(19) United States
(12) Patent Application Publication
(10) Pub. No.: US 2003/0177142 A1
(43) Pub. Date: Sep. 18, 2003

(54) Method of and apparatus for broadcasting databases

(76) Inventor: Gavin Robert Ferris, London (GB)

Correspondence Address: Richard C Woodbridge, Woodbridge & Associates, P O Box 592, Princeton, NJ, 08542-0592, US

(21) Appl. No.: 10/343,809

(22) PCT Filed: Aug. 3, 2001
(86) PCT No.: PCT/GB01/03500

(30) Foreign Application Priority Data
Aug. 3, 2000 (GB) 0019011.6

(51) Int. Cl. H04H 1/00; G06F 7/00; G06F 17/00

(52) U.S. Cl. 707/104.1; 707/102; 455/3.01

(57) ABSTRACT

A method of User broadcasting data using wireless communication in which the data is extracted from a source SQL database and broadcast to a receiving device programmed to reconstruct the data into a SQL database.

### BACK GROUND OF THE INVENTION

1. Field of the Invention

This invention relates to a method of and apparatus for broadcasting data, particularly data relating to databases, using wireless communication. The term ‘wireless communication’ encompasses any system of wireless communication, including Eureka-147 DAB (‘Digital Audio Broadasting), Internet broadcasting, DVB, ISDB-T, DRM, IBOC, 802.11 and Bluetooth™.

2. Description of the Prior Art

Wireless communication has historically focussed on delivering voice content (e.g. cellular radio systems such as GSM) and entertainment (e.g. television). However, emerging wireless communication technologies such as Eureka-147 (or ‘DAB’—Digital Audio Broadcasting) and packet based 3G cellular telephony, offer the promise of delivering data to so-called ‘wireless information devices’. These devices will typically combine the functionality of an electronic personal organiser with voice and/or data communications capabilities. For example, a data-centric wireless information device may display broadcast data covering news, stock quotes, and EPGs (electronic programme guides).

One of the most compelling and pervasive information management solutions is the database: it has been estimated that perhaps 80% of current commercial computing activity relies on databases. A database is simply a set of useful information held in a structured electronic form. A relational database is one which is constructed from a number of inter-linked tables, each of which holds a number of rows of information (records) split into columns (fields). Each of these fields may have one of a number of types (integer, string, Boolean, etc.), and possibly also constraints upon content. The logical structure of the database tables is known as the schema. One popular language that allows the specification of schemas is called SQL—the structured query language. Once a database schema has been established for a particular application, the next logical operation is to populate the empty tables so created with data. Again, this can be done through SQL commands. Finally, once a database has been populated, SQL queries may be used to extract the data, which matches certain structured criteria (e.g., houses less than a certain price, programmes on a particular channel between certain times, etc.). Of course, a database can be updated (via record modifications, additions and deletions) at any time (although transactions may be used to ensure a consistent view across e.g., a multiple query session).

Databases(including SQL databases) are routinely accessed over wire based networks, such as the internet. However, the present invention does not deal with this situation. Instead, it deals with the very different situation of broadcasting databases over a wireless communications link. The ability to effectively broadcast a database using wireless communication is currently very limited. There are two main kinds of solutions to database broadcast: first, the use of a fully-custom database marshalled for each application. Secondly, the use of highly non-standard distribution systems, such as the TPEG system specified within DAB.

Some wireless communication systems have been specifically designed to accommodate data transfer (although not database transfer). For example, DAB provides a low-cost-per-bit mechanism for data transfer, which, when used in conjunction with the multimedia object transport (‘MOT’) standard carousel technology, allows virtual filing systems (‘VFS’) to be sent ‘over the air’ from a central station to a set of targets. The broadcast web site (‘BWS)’ application runs over this MOT/DAB platform, providing the ability to transmit carousels of HTML files and associated media.

However, useful though this mechanism is, it does not by itself cater for databases. This is a major drawback, since, as noted above, the majority of current computing tasks involve the use of database technology in some form or other.

DAB does however provide for the distribution of lightweight database structures using the TPEG system. However, this is a specialised mechanism not in line with the industry standards. Consequently, TPEG is of limited commercial use.

### SUMMARY OF THE PRESENT INVENTION

The first aspect of the present invention is a method of broadcasting data using wireless communication in which the data is extracted from a source SQL database and broadcast to a receiving device programmed to reconstruct the data into a SQL database.

In one implementation, the method of comprises the steps of:

(a) extracting schema defining the source SQL database;

(b) rendering the schema into a form suitable for transmission;

(c) transmitting the schema in its rendered form using wireless communication, with the objective that the schema in its rendered form is received at a receiving device and used to construct an empty SQL database at the receiving device.

In a second aspect, there is a method of receiving, at a receiving device, data broadcast using wireless communication, in which the broadcast data has been extracted from a source SQL database and is reconstructed into a SQL database at the receiving device. The following steps may be performed at the receiving device:

(a) receiving schema, rendered into a form suitable for transmission, in which the schema define the source SQL database and

(b) constructing an empty SQL database using the schema.

In a third aspect, there is an apparatus programmed to perform the method of broadcasting data defined above and elsewhere in this specification.

In a fourth aspect, there is a device programmed to perform the method of receiving data as defined above and elsewhere in this specification.

In a fifth aspect, there is a database application adapted to use data broadcast using the method of broadcasting data defined above and elsewhere in this specification.

In a sixth aspect, there is a database application adapted to use data received using the method of receiving data as defined above and elsewhere in this specification.

In a seventh aspect, there is computer software programmed to perform the method of broadcasting data defined above and elsewhere in this specification.

In an eight aspect, there is computer software programmed to perform the method of receiving data as defined above and elsewhere in this specification.

In a ninth aspect, there is an e-commerce transaction system comprising one or more servers providing data to be broadcast using the method of broadcasting data defined above and elsewhere in this specification and receiving purchase requests issued by one or more receiving device using a back channel.

A preferred implementation is the broadcast database (“BDB”) application from Radioscape Limited of London, United Kingdom. The BDB application allows industry standard SQL databases (including schemas, record contents and queries) to be mapped into an MOT carousel for transmission over the Eureka 147 DAB protocol. It provides a scalable approach to the receiver-side implementation, allowing simple (e.g., car radio) receivers to decode individual tables and perform simple select queries, whilst at the same time facilitating the use of complex execution engines (such as PC-based receivers), which can utilise the full power of SQL. It also forms an appropriate platform for implementation of certain key higher-level applications that are primarily driven by structured data, such as the EPG (electronic programme guide), ‘classified’ advertisements, etc. BDB can include a back channel so that it can provide a complete e-commerce transaction platform extending from information broadcast to product purchase. BDB is discussed in depth in the Detailed Description section of this specification.

### BRIEF DESCRIPTION OF THE DRAWING

FIG. 1 is a schematic illustrating the BDB implementation of the present invention.

### DETAILED DESCRIPTION

The present invention will be described with reference to the BDB implementation.

### BDB Design Objectives

From the above analysis, we can see that there are a number of important tasks that the BDB system must handle:

1. Extraction of the schema from an SQL database and transmission of the same via an MOT carousel, along with the mechanism for a corresponding receiver-side client to reconstruct an empty database with an identical schema.

2. Mapping of the data contained with the SQL database into a format suitable for transmission via an MOT carousel, along with the mechanism for a corresponding receiver-side client to populate the database structure transmitted in 1) above.

3. Mapping appropriate query operations into a format suitable for transmission via an MOT carousel, along with the mechanism for a corresponding receiver-side client to present users with the ability to apply pre-packaged structured queries to the database transmitted via 1) and 2).

Additional important criteria include:

4. Appropriate signalling. The use of a BDB application should be signalled appropriately via the Fast Information Channel (‘FIC’). It should also be possible to provide higher-level applications that use the BDB in a structured way (for example, the EPG), where these applications may have a fixed, published schema.

5. Simplicity of mapping. It should be possible for low-cost receivers without complex processing engines to be able particularly if they know the schema for a particular application, e.g., the EPG) to be able to access particular tables and make simple queries. It would be of benefit to be able to split receivers into various profiles from this point of view.

6. Efficient use of bandwidth without excessive complexity. Traditionally, DAB high-level protocols (e.g., FIGs, TPEG, etc.) have been parsimonious about resource usage, but at the cost of complexity. The BDB application should aim for simplicity, whilst still providing efficient use of resources. This strongly suggests the use of high-level lossless compression technologies.

7. Ability to plug into industry standard databases at both the transmission and receiver sides—this requires more than just SQL, it also requires an appropriate interface through which databases may be activated, SQL commands carried out, etc.

8. Platform neutrality. The client-side code should be able to be executed on a number of different high-level platforms (N.B., this is a distinct point from 2).

9. Use of layering, rejection of the NIH (‘not invented here’) philosophy. The BDB should make use of whatever appropriate standard technologies are available within DAB, rather than inventing new ones. It should also provide a generic, reusable application service to higher level applications that depend upon database distribution technology (e.g., the EPG). The goal is to provide a reusable service element that will greatly extend the utility of DAB without excessive amounts, of development effort.

An appropriate implementation of the BDB is therefore a significantly complex task. In the following text, we discuss a suggested system design to meet the above objectives.

### BDB Design Overview

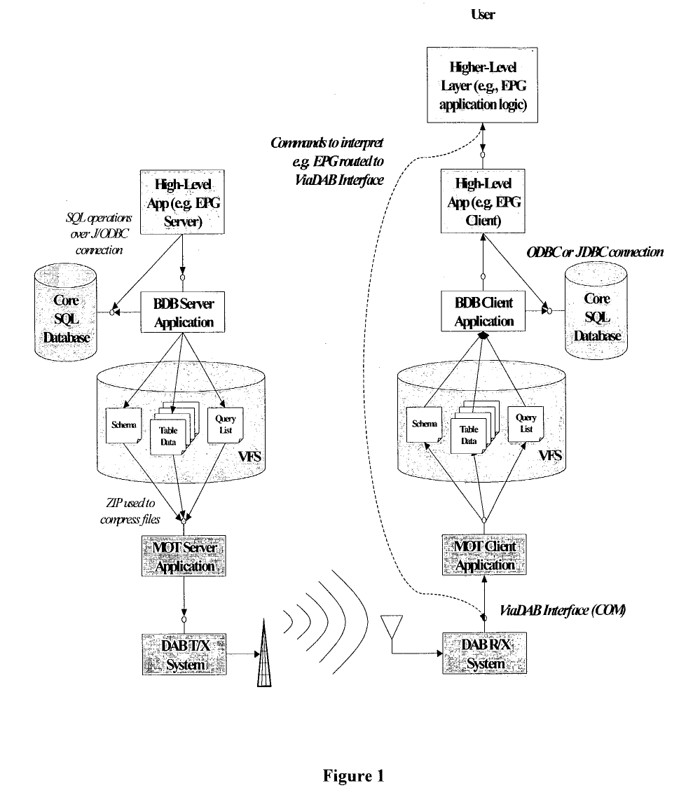

The BDB will be implemented as an application over MOT (the multimedia object transport standard). MOT is an established mechanism within DAB that enables a virtual filing system (‘VFS’) to be transported from a transmission site to a multiplicity of receivers, in which the constituent files are repeated in a carousel to ensure that a desired document will eventually be retrieved, no matter at which point a receiver commences decoding. This satisfies the ‘reuse’ part of the layering requirement at point (9). Files, which are to be transmitted in this manner, will be zipped prior to transmission, to minimse bandwidth. In this way, good utilisation of the air interface can be maintained, without excessive complexity in the coding infrastructure (a demerit that has traditionally afflicted the Eureka 147 DAB system). The overall architecture is shown in FIG. 1. According to this architecture, a high level application (for example, an electronic programme guide or EPG) will use, as its primary data store, a standard SQL database. The connection to the database will either be an ODBC or JDBC database handle. Using the exposed part of the BDB server application (over D/COM), the application will instruct this component of key commands with respect to the core SQL database (e.g., schema constructed, viable baseline ready for transmission, edits made, etc.).

Once a core schema has been defined, the first step for the BDB server is to render this into a form suitable for transmission over using the MOT protocol. To enable this, the SQL command sets for the schema definition are simply listed as text files, together with an overview parameter file, and sent to the MOT carousel. It is expected that, in normal use, the BDB server will require the MOT server to statistically multiplex the schema data as a high priority plane within the carousel. Note that it is expected that, for key applications such as the EPG, the schema core will be published independently, enabling (as shall be expounded later) the decoding of important tables by relatively unsophisticated receivers. The SQL schema description text files will be subject to lossless compression prior to transmission.

Next, once an appropriate baseline table dataset has been established (e.g., the core set of week's programmes as been written into the SQL EPG database), the higher level application can require the BDB server to render this data into the MOT VFS. This will be done by writing out each record within each table into an XML file. These XML files will be grouped into virtual directories corresponding to their table. The resulting XML file set will be subject to lossless compression prior to transmission. The BDB server will request the MOT carousel to statistically multiplex this file plane with normal priority.

Finally, ‘canned’ queries to the database, together with limited edits (such as record deletions, insertions and edits) will be tendered as their appropriate SQL text and transmitted after appropriate lossless compression. These files will be requested to be statistically multiplexed in a reasonably high priority plane of the MOT carousel. Note that the MOT index file will provide a complete inventory of the current ‘wavefront’ of required files for a complete and consistent view of the database.

On the receiver side, an inverse process will take place. At the highest level, a user application (e.g., the EPG application logic) will, having been triggered from the signalling of an appropriate content stream), generate an instance of the appropriate client application. Following out example, it would therefore construct an EPG client, which might execute as a Java application. This client, in turn, would connect itself to an appropriate database on the client side, using either an ODBC or JDBC handle (see below for a discussion of decoding on low-sophistication receivers). This handle would originally be constructed by the higher-level app and would be passed to the BDB client as part of the initialisation process.

The BDB client will, in its turn, connect to an underlying MOT client, which it will then request (through the appropriate ViaDAB API) to connect to and decode an appropriate data service component (whether passed in XPAD, a packet mode service component or a stream mode data service component). The location of this data will have been part of the original signalling that caused the high-level user application to have been spawned in the first place.

As soon as the MOT server notifies the client that the schema data has been received, the BDB client will use this data to build an ‘empty database’ tableset within the database pointed to by the given JDBC or ODBC handle. Next, once the XML data is completely received, this will be used to drive inserts into the database over the same handle. Finally, any updates, deletions or modifications will be executed immediately on the database thus constructed, and ‘packaged’ queries will be passed through to the application logic.

Events, signalling these various stages of the database's life on the client side, will be sent to an outgoing interface of the high-level user application by the BDB client. At an appropriate stage (e.g., when the complete current ‘wavefront’ as signalled using the MOT index file is present within the local database copy), the high-level user application will then be able to present the data to the user.

For example, in our EPG application, we might have a simple database viewer fired off to show the user which programmes are coming up on what channels for the next week. The important point here is that the high-level application will be querying a standard database using standard SQL, and in virtue of this it will be able to be executed using any number of third party, rapid application development, tools and technologies. Therefore, an extremely rich experience can be provided at low cost to the end user, and this can extend in a straightforward manner to direct access over a twoway, Internet connection. The importance of the use of such an industry standard as SQL should not be underestimated.

The loop is then closed by the high-level application layer. For example, our EPG application might provide the user with the ability to simply select any future programme and add it to a ‘record’ list. In such an event, the application would keep track of all the ‘booked’ recordings and, just before one was due to occur, would use a direct ViaDAB connection to the underlying receiver to instruct it to tune to the appropriate multiplex and start recording to file the appropriate service. In this way, the EPG can be provided in an extremely rich and sophisticated manner without undue ‘infection’ of the rest of the code.

### Implementation on Low-Sophistication Receivers

It is clear how the BDB applies to sophisticated receivers running some form of virtual machine, and on which SQL databases may be implemented. However, it is important to appreciated that the design is also intended to facilitate operation on relatively low-sophistication devices also (e.g., a car radio with a quarter VGA display panel).

To enable this, a number of concepts are employed:

A receiver profile is introduced. This allows receivers to be categorized into strata depending upon their ability to utilise SQL. At least two levels should be used, although this could be refined later: a simple receiver capable only of single variable, single table select queries, and one capable of running full-blown SQL 7.

For key applications, the core schema itself should be published (e.g., for the EPG, the layouts and data types of each of the tables would be published as a standard). Note that this does not prevent ‘orthogonal’ additions to these standards being implemented, e.g., through the addition of extra tables keyed from data in the core set. However, it does allow for ‘hard coded’ applications that only operate on a single table within the set, or a small number of tables. The use of ‘hard coded’ query templates should also be a possible part of a BDB application published for use in this manner.

As described above, the data corresponding to one table should be transmitted in one virtual directory of the MOT VFS and each record within the table should be one file within the VFS, and a simple encoding (XML is proposed) should be used to code the record contents. In this way, even a simple receiver that can decode MOT carousels, and has foreknowledge of the appropriate schema, can access the files containing the record data and search, present and otherwise manipulate this data directly, without recourse to SQL.

In this way, the BDB encoding provides a scalable approach to implementation.

### Signalling

The BDB application (and applications dependent upon it, such as the EPG) will require appropriate signalling in the FIC. It is suggested that FIG. 0/13 signalling is used to enable transmission of core database parameters BDB client profile, database versioning, etc.).

### Analysis of the Design

The design above meets the key objectives set out at the beginning of the Detailed Description section of this specification. Specifically:

1. Extraction of the schema of an SQL database is handled in a straightforward manner, since the target is also an SQL database, the SQL command set to construct the appropriate empty tableset simply needs to be tendered as text, compressed, and sent via an MOT carousel (as discussed above).

2. Straightforward data mapping is provided by the use of per-table VFS directories, and per-record VFS file mappings, together with the use of XML (which could, e.g., be straightforwardly generated via an appropriate active server page or other third-party tool) as the record content mapping. The encoding is extremely transparent.

3. Packaged queries are handled though the use of mapping their SQL command set into text (possibly, in one preferred embodiment, parameterised by the key query variables) which is then compressed and sent using the underlying MOT carousel.

4. Signalling is straightforward, being an orthogonal extension to an MOT data service FIC signalling set, and higher level access (as shown in the worked example of the EPG) is straightforwardly possible thorough the exposed BDB COM interfaces.

5. Simplicity of mapping has been achieved, together with the use of profiles. As described above, this allows simple receivers to access the data without undue complexity, whilst allowing those receivers with full-database support (e.g., PCs) to use all the sophistication of existing third-party tools, allowing extremely powerful visualisation and query mechanisms to be brought into play without additional development effort.

6. Efficient use of bandwidth has been achieved, though the use of lossless compression (a dictionary-based Huffman scheme is used in one preferred embodiment). Because the file to record mapping is straightforward (as discussed above) and because the post-compression record serialisation format is also straightforward (being based upon an industry standard, namely XML), the scheme is relatively transparent to developers and amenable to use on low-sophistication receivers, but not at the expense of bandwidth efficiency.

7. The ability to ‘plug in’ to third-party SQL databases has been met, firstly, through the use of SQL itself as the common BDB ‘lingua franca’, and secondly, though the paired BDB server-client, which execute the appropriate database accesses described in the transmitted SQL over OBDB or JDBC handles.

8. The design achieves platform neutrality, since (in one preferred embodiment), both the BDB client and server components are implemented in Java and use JDBC to access the underlying database. They proffer COM interfaces to the higher-level applications (this standard being platform-independent), and only depend upon COM interfaces to the services below them (namely, the ViaDAB receiver and MOT data carousel server and client interfaces).

9. Layering is supported very strongly. The BDB makes use of existing DAB services (MOT, ViaDAB) and existing database technology (SQL, ODBC, JDBC). It allows higher-level applications to be built on top of it, which are (at the data level) describable simply in terms of their interactions with an SQL database and, in virtue of which, are DAB independent. However (and as is shown in the EPG example above) this does not rule out a higher level application which presents this information actively to a user and then performs some DAB specific operations in response either to the data itself or the user's response to this data (or some combination of both). Since a vast array of third-party tools exist to build, back up, query, visualise and check SQL databases, the BDB application provides an extremely appropriate ‘layer’ of functionality that will greatly extend the DAB platform.

10. The BDB can allow databases distributed by CD-ROM or pulled from the Internet to be efficiently updated: merchants could issue CD-ROMs of large catalogues of information, and use BDB to update that database.

11. The BDB table data can readily include a flag indicating by what date or for how long it should be allowed to remain in a client database before being deleted: hence, TV listings information can be set to be deleted automatically the day after its day of relevance; stock information can be deleted after 30 minutes if not automatically refreshed.

12. The BDB can enable a broadcast database (such as a broadcast web-site) to be viewed using several different applications operating as GUIs. Hence, for example, a database comprising general listings of musical events of all categories could be the broadcast database; a classical radio channel could offer a GUI to that information which in effect links to the database and acts as a filter, showing only classical music listings. The database could also link to a different GUI, perhaps from a jazz radio station, which would filter only jazz related events.

### Conclusions

The design for the BDB presented here provides a highly scalable extension to the DAB architecture, which would also be suitable for use in any other system where broadcast content bandwidth needs to be used to provide applications which find themselves best described as ‘a database with GUI attached’. Since this description fits perhaps 80% of current commercial activity within computing, and since the RadioScape solution enables the use of industry standard technologies to provide such an ‘air-distributable’ database, it is straightforward to appreciate that it offers significant advantages over the current state of the art (which requires the use either of a fully-custom database marshalling for each application, or the use of highly non-standard distribution systems such as TPEG). The potential applications for the BDB are too numerous to discuss in detail here, but it is perhaps worth mentioning a few. We have already presented the EPG as a worked example. Other possibilities include the distribution of classified advertising over DAB (e.g., car prices, real estate details), price distribution by supermarkets to their branches, ‘closed user group’ data services such as Reuters-style stock and news feeds, etc. These can all be built, with the aid of the BDB, by existing IT staff using their familiar tools and technologies (e.g., SQL, Oracle, Forms etc.). In addition, the technology is in no sense limited to Eureka-147 DAB but could rapidly be deployed onto any broadcast or multicast medium (e.g., Internet broadcast, DVB, ISDB-T, DRM, IBOC, Bluetooth, etc.). Where a backchannel is available, additional functions can of course be provided to allow (e.g.) particular clients to query for MOT elements that they may have missed or which have been corrupted by the channel (where one exists), or to pass specific one-to-one commands back to the server to allow (e.g.) purchasing of goods offered.

1. A method of broadcasting data using wireless communication in which the data is extracted from a source SQL database and broadcast to a receiving device programmed to reconstruct the data into a SQL database.

2. The method of claim 1 comprising the steps of:
(a) extracting schema defining the source SQL database;
(b) rendering the schema into a form suitable for transmission;
(c) transmitting the schema in its rendered form using wireless communication, with the objective that the schema in its tendered form is received at a receiving device and used to construct an empty SQL database at the receiving device.

3. The method of claim 2 comprising the steps of
(a) rendering a schema defining the source SQL database into a form suitable for transmission by listing a command set defining the schema as text;
(b) sending this text to a transport mechanism which is a carousel-based virtual filing system.

4. The method of claim 3 in which the wireless communication is Eureka-147 and the transport mechanism is a Mutlimedia Object Transport (MOT).

5. The method of claim 3 or 4 in which the schema description text files are subject to lossless compression prior to transmission.

6. The method of claims 2-5 comprising the steps of:
(a) extracting table data from the source SQL database;
(b) rendering that table data into a form suitable for transmission;
(c) transmitting the table data using wireless communication, with the objective that the table data in tendered form is received at a receiving device and used to populate the empty SQL database at the receiving device.

7. The method of claim 6 in which the table data is organised as XML files.

8. The method of claim 7 in which the XML files ate subject to lossless compression prior to transmission.

9. The method of claims 2-8 comprising the steps of:
(a) extracting a query list from the source SQL database;
(b) tendering the query list into a form suitable for transmission;
(c) transmitting the query list using wireless communication with the objective of the tendered query list being received at a receiving device and being passed to an application on the receiving device, in which the application is programmed to allow a user to apply structured queries to the SQL database at the receiving device by using the query list.

10. The method of claim 9 in which the query list is subject to lossless compression prior to transmission.

11. The method of any preceding claim in which the receiving device is programmed with the schema definition without the schema definition being broadcast.

12. A method of receiving, at a receiving device, data broadcast using wireless communication, in which the broadcast data has been extracted from a source SQL database and is reconstructed into a SQL database at the receiving device.

13. The method of receiving data as claimed in claim 12, in which the data is broadcast using a method as claimed in any of claim 1-11.

14. The method of claim 12 or 13 comprising the following steps performed at the receiving device:
(a) receiving schema, tendered into a form suitable for transmission, in which the schema define the source SQL database and
(b) constructing an empty SQL database using the schema.

15. The method of claim 14 comprising the following steps performed at the receiving device:
(a) receiving table data, rendered into a form suitable for transmission, in which the table data define the contents of the source SQL database and
(b) populating the empty SQL database at the receiving device with the table data.

16. The method of claim 14-15 comprising the following steps performed at the receiving device:
(a) receiving a query list, rendered into a form suitable for transmission, in which the query list defines several structured queries which may be performed on the source SQL database and
(b) passed the query list to an application on the receiving device, in which the application is programmed to allow a user to apply structured queries to the SQL database at the receiving device by using the query list.

17. An apparatus programmed to perform the method of claims 1-11.

18. A device programmed to perform the method of claims 12-16.

19. A database application adapted to use data broadcast using the method of claims 1-11.

20. A database application adapted to use data received using the method of claims 12-16.

21. Computer software programmed to perform the method of claims 1-11.

22. Computer software programmed to perform the method of claims 12-16.

23. An e-commerce transaction system comprising one or mote servers providing data to be broadcast using the method of claims 1-11 and receiving purchase requests issued by one or more receiving device using a back channel.
